(19) United States
(12) Patent Application Publication
(10) Pub. No.: US 2009/0146630 A1
(43) Pub. Date: Jun. 11, 2009

(54) SEMICONDUCTOR DEVICE

(75) Inventor: Toshiyuki NAKA, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/327,118

(22) Filed: Dec. 3, 2008

(30) Foreign Application Priority Data
Dec. 5, 2007 (JP) 2007-314551

(51) Int. Cl. G05F 1/10

(52) U.S. Cl. 323/283

(57) ABSTRACT

A semiconductor device includes: a digital control circuit configured to supply two semiconductor switching elements connected in series in a switching power supply circuit with a pulse signal for turning on/off the semiconductor switching elements; and a dead time setting circuit configured to set a dead time in which the two semiconductor switching elements are both turned off. The dead time setting circuit includes: a delay generation circuit including a plurality of delay elements connected in series and having mutually different delay values; and a delay adjustment circuit configured to adjust the delay values of the delay generation circuit so that a setting value of the dead time is determined on basis of correlation between the dead time and the duty cycle of the pulse signal.

### CROSS-REFERENCE TO RELATED APPLICATIONS

This application is based upon and claims the benefit of priority from the prior Japanese Patent Application No.2007-314551, filed on Dec. 5, 2007; the entire contents of which are incorporated herein by reference.

### BACKGROUND OF THE INVENTION

1. Field of the Invention

This invention relates to a semiconductor device, and more particularly to a semiconductor device including a circuit in which a semiconductor switching element is digitally turned on/off to produce a desired output.

2. Background Art

In a switching power supply such as a DC-DC converter including a high-side and low-side switching element (power transistor) which are alternately turned on/off by a PWM (pulse width modulation) signal, a dead time for allowing both the power transistors to be turned off is provided to avoid a shoot-through current due to simultaneous turn-on of the power transistors.

The dead time affects the efficiency of the DC-DC converter (output power/input power). In general, at design time, a suitable value of the dead time is calculated, and the circuit is designed to achieve that value. However, in practice, due to variations in switching elements, this method cannot optimize the dead time for all the elements. Consequently, the value of the dead time is designed in consideration of variations between the elements even at some expense of efficiency.

Vahid Yousefzadeh and Dragan Maksimovic, “Sensorless Optimization of Dead Times in DC-DC Converters with Synchronous Rectifiers”, APEC (IEEE Applied Power Electronics Conference and Exposition) '05, proposes a dead time optimization control based on the idea that “the efficiency of a DC-DC converter is maximized when the duty cycle of the switching pulse is minimized”. Starting from a relatively long initial value, the dead time is gradually decreased while measuring and holding the duty cycle. When the duty cycle increases, the dead time is returned to the last value, which is selected as the optimal dead time.

Furthermore, a delay generation circuit including numerous delay elements is used to obtain a higher resolution in dead time adjustment than the fundamental clock (to adjust the pulse edge with a smaller increment than the clock cycle). Currently, it is difficult to exactly divide one clock cycle into n (e.g., 32). Hence, the delay generation circuit includes numerous units connected in series, each unit including a delay element having a onefold delay value and a delay element having a twofold delay value connected in parallel, and the overall path is determined by suitably selecting the path of the onefold delay value and the path of the twofold delay value so that the total delay value (delay time) does not exceed the fundamental clock cycle. However, this configuration requires numerous delay elements, and hence increases the space for the delay generation circuit in the semiconductor chip and the power consumption. This delay generation circuit is needed only in setting the dead time, and once an optimal setting value of the dead time is determined, the setting value subsequently continues to be used without change. Hence, it is desired to avoid wastefully increasing the circuit scale and power consumption of the delay generation circuit only for that purpose.

### SUMMARY OF THE INVENTION

According to an aspect of the invention, there is provided a semiconductor device including: a digital control circuit configured to supply two semiconductor switching elements connected in series in a switching power supply circuit with a pulse signal for turning on/off the semiconductor switching elements; and a dead time setting circuit configured to set a dead time in which the two semiconductor switching elements are both turned off, the dead time setting circuit including: a delay generation circuit including a plurality of delay elements connected in series and having mutually different delay values; and a delay adjustment circuit configured to adjust the delay values of the delay generation circuit so that a setting value of the dead time is determined on basis of correlation between the dead time and the duty cycle of the pulse signal.

According to another aspect of the invention, there is provided a semiconductor device including: a digital control circuit configured to supply two semiconductor switching elements connected in series in a switching power supply circuit with a pulse signal for turning on/off the semiconductor switching elements; and a dead time setting circuit configured to set a dead time in which the two semiconductor switching elements are both turned off, the dead time setting circuit including: a delay adjustment circuit configured to adjust the delay values of the delay generation circuit so that a setting value of the dead time is determined on basis of correlation between the dead time and an output voltage of the switching power supply circuit.

### BRIEF DESCRIPTION OF THE DRAWINGS

FIG. 1 is a circuit diagram of a step-down DC-DC converter based on a semiconductor device according to a embodiment of the invention;

FIG. 2 is a circuit diagram showing a specific example of the dead time setting circuit shown in FIG. 1;

FIG. 3 is a waveform diagram of output voltage Vout of the switching power supply circuit shown in FIG. 1; and

FIG. 4 is a flow chart showing the dead time optimization algorithm in the dead time setting circuit shown in FIG. 1.

FIG. 5 shows graphs of dead time, efficiency and duty cycle in the DC-DC converter according to the modification of the embodiment of the invention.

FIG. 6 shows graphs of dead time, efficiency and output voltage in the DC-DC converter according to the modification of the embodiment of the invention.

### DETAILED DESCRIPTION OF THE INVENTION

An embodiment of the invention will now be described with reference to the drawings.

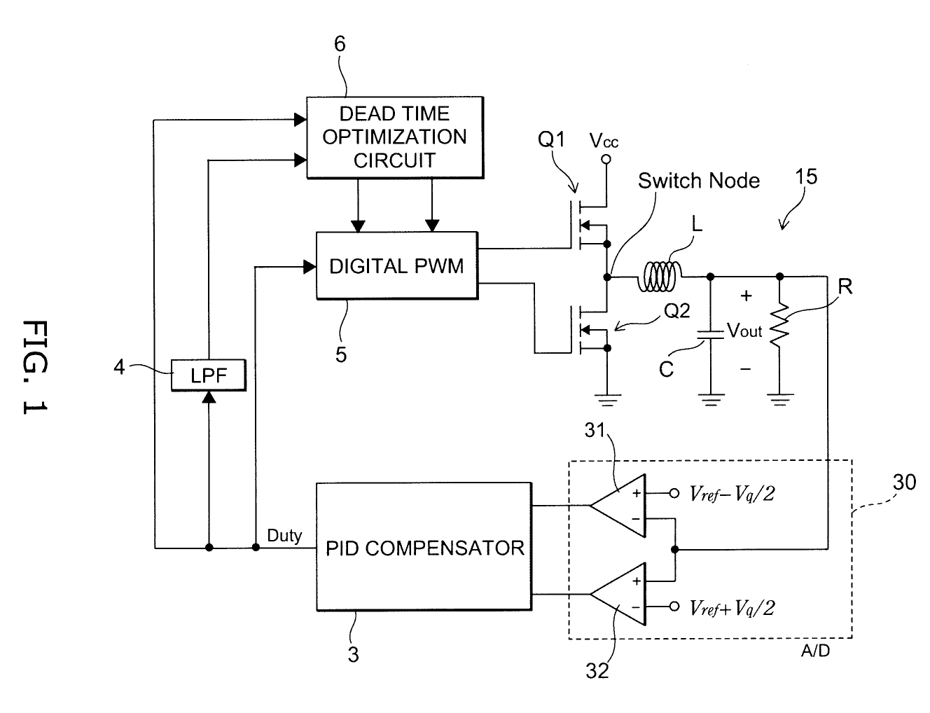

A semiconductor device according to the embodiment of the invention illustratively includes, in the circuit shown in FIG. 1, switching elements Q1 and Q2, an A/D conversion circuit 30, a PID (proportional-integral-derivative) compensator 3, a low-pass filter 4, a digital control circuit 5, and a dead time setting circuit 6, which are formed on a semiconductor substrate and integrated into one chip.

The circuit shown in FIG. 1 is a DC-DC converter, broadly divided into a switching power supply circuit 15 including the switching elements Q1 and Q2, an inductor L, a capacitor C, and a load R, and a control circuit for controlling the operation of this switching power supply circuit 15.

This DC-DC converter is a step-down DC-DC converter (buck converter) for producing an (average) output voltage Vout lower than the input voltage Vcc by alternately turning on/off the high-side switching element Q1 and the low-side switching element Q2. The two switching elements Q1 and Q2 are series connected at a switch node, which is the junction between the input source of the input voltage Vcc and ground, and a rectangular wave is outputted at the switch node. The rectangular wave is smoothed by a filter composed of the capacitor C, and the output voltage Vout is obtained at the load R.

Each switching element Q1, Q2 is illustratively a MOSFET (metal-oxide-semiconductor field effect transistor), and each gate is connected to the digital control circuit 5. The digital control circuit 5 is illustratively a PWM (pulse width modulation) circuit, supplying a gate driving signal (switching pulse) to the gate of the switching elements Q1 and Q2.

The source-drain path of the high-side switching element Q1 is connected between the input source of Vcc and the switch node. The source-drain path of the low-side switching element Q2 is connected between the switch node and ground. The switch node, which is the junction between the two switching elements Q1 and Q2, is connected to the load R through the inductor L.

To control on/off of the switching elements Q1 and Q2, a switching pulse having a nearly inverted phase is supplied from the digital control circuit 5 to each gate of the switching elements Q1 and Q2.

The switching duty cycle of the switching elements Q1 and Q2 determines the degree and rate of decrease of the output voltage Vout corresponding to the load condition and the input voltage Vcc. When the switching element Q2 is turned off and the switching element Q1 is turned on, a current flows through the switching element Q1 to the inductor L and increases the inductor current, which accumulates energy in the inductor L. When the switching element Q1 is turned off and the switching element Q2 is turned on, the inductor L discharges an inductor current by its accumulated energy (back electromotive force), and a back-flow current flows from ground through the switching element Q2 to the inductor L. The capacitor C serves as a low-pass filter to reduce output ripple noise resulting from the variation of the current flowing through the inductor L.

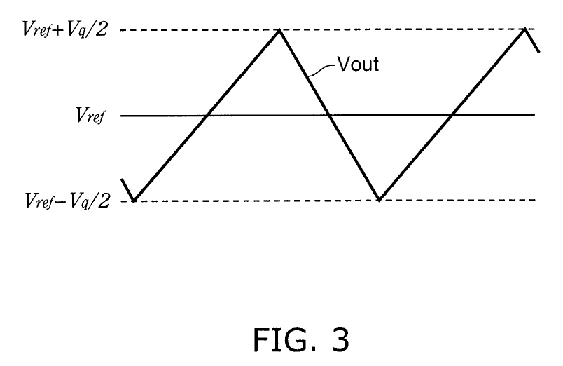

The output voltage Vout is controlled within a voltage control width Vq around Vref as shown in the waveform diagram of FIG. 3. The output voltage Vout is A/D converted by the A/D conversion circuit 30 and inputted as a two-bit signal to the PID compensator 3.

The A/D conversion circuit 30 includes two comparators 31 and 32. The comparator 31 outputs the result of comparison between the output voltage Vout and Vref−Vq/2 to the PID compensator 3, and the comparator 32 outputs the result of comparison between the output voltage Vout and Vref+Vq/2 to the PID compensator 3. In response to these signals, the PID compensator 3 calculates the duty cycle of the switching pulse outputted by the digital control circuit 5, and outputs the duty cycle to the digital control circuit 5.

When the two switching elements Q1 and Q2 are simultaneously turned on, a very large current (shoot-through current) flows through the two switching elements Q1 and Q2 to ground. To avoid this, the switching element Q1 and the switching element Q2 are alternately turned on/off with a dead time in which the two switching elements Q1 and Q2 are both turned off.

The dead time is set by the dead time setting circuit 6. The present duty cycle outputted by the PID compensator 3 is inputted to the dead time setting circuit 6. Furthermore, the output of the PID compensator 3 is passed through the low-pass filter 4 to calculate the running average of the duty cycle, which is also inputted to the dead time setting circuit 6. As described later, the dead time setting circuit 6 determines the optimal value of the dead time on the basis of comparison between the present duty cycle and the running average of the duty cycle, and outputs the optimal value to the digital control circuit 5.

If the duty cycle of the above switching pulse is small, the efficiency of the DC-DC converter (output power/input power) increases. Hence, the dead time that minimizes the duty cycle (within an allowable range) to maximize the efficiency is the optimal value (setting value).

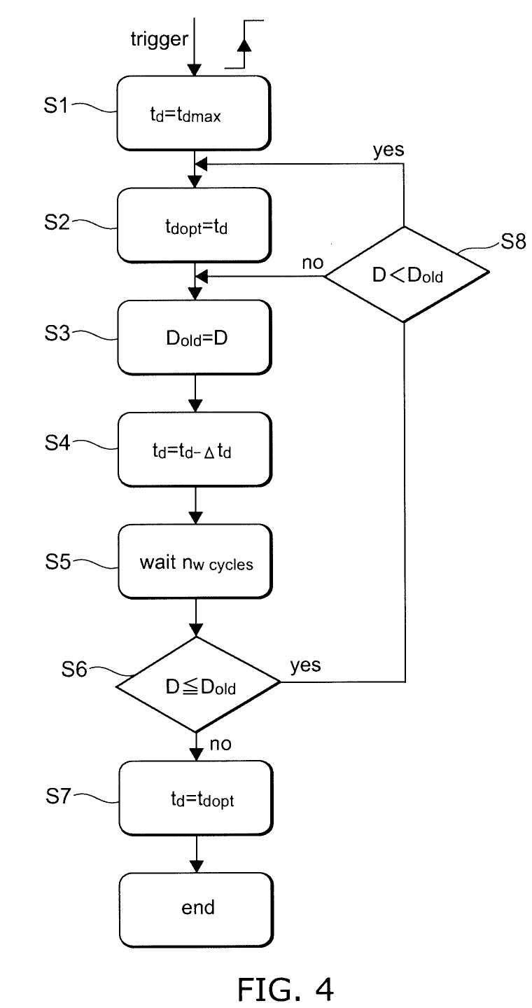

FIG. 4 shows a flow chart of the dead time optimization algorithm.

First, step S1 is started at the rising edge of the trigger pulse. In this step S, the dead time t_{d} is set to a relatively long initial value t_{dmax}.

Next, in step S2, let t_{dopt}=t_{d} (equal to t_{dmax} as set in step S1). Next, in step S3, the present duty cycle (the duty cycle before the dead time t_{d} is decreased in the next step S4) D is stored as D_{old}.

Next, in step S4, the present dead time td is decreased by Δt_{d}. That is, let t_{d}=t_{d} (t_{dopt} in step S2)−Δt_{d}. This is followed by a wait of a few seconds (step S5).

Next, in step S6, comparison is made between the present duty cycle (the duty cycle after the dead time is decreased in step S4) D and the duty cycle D_{old}, which was stored in step S3 before the dead time is decreased in step S4.

Here, if the duty cycle D is larger than the previous duty cycle D_{old}, the result of step S6 is “no”, and the flow proceeds to step S7.

In step S7, the dead time t_{dopt}, which was set in step S2 before the dead time is decreased in step S4, is selected as the optimal value (setting value) of the dead time minimizing the duty cycle, and the flow is terminated.

In step S6, if the duty cycle D is equal to or smaller than the previous duty cycle D_{old}, the result of step S6 is “yes”, and the flow proceeds to step S8.

In step S8, if the duty cycle D is smaller than the previous duty cycle D_{old}, the result is “yes”, and the flow proceeds to step S2. In this step S2, t_{d}−Δt_{d} in step S4 of the previous cycle is set to t_{dopt}. Hence, in step S4 of this cycle, the dead time t_{d} is further decreased by Δt_{d} as compared with the previous cycle, and like the foregoing, it is determined in step S6 how the duty cycle varies in response to this dead time.

In step S8, if the duty cycle D is equal to the previous duty cycle D_{old}, the result is “no”, and the process from step S3 onward is repeated again. Because this cycle has not passed through step S2, the dead time t_{d} in step S4 of this cycle is equal to the dead time t_{d} in step S4 of the previous cycle.

A DC-DC converter has high efficiency if the duty cycle of the switching pulse is small, whereas the duty cycle is small if the dead time is small. Thus, as in the above flow, starting from a relatively long initial value tdmax, the dead time t_{d} is gradually decreased while measuring and holding the duty cycle, and this is continued until the duty cycle increases from the previous value. When the duty cycle increases, the dead time is returned to the last value, which is selected as the optimal value (setting value).

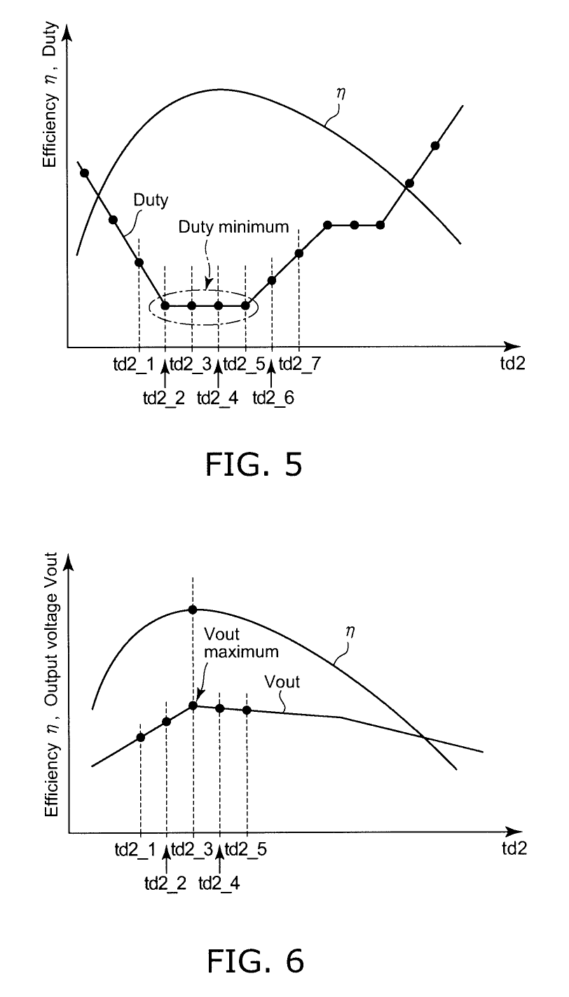

FIG. 5 shows graphs of efficiency and duty cycle versus the dead time. As shown, suppose that the dead time at which the duty cycle is minimum is td2_2, td2_3, td2_4 and td2_5. The above embodiment has been described taking an example of using one of these dead times as the optimum value. However, it is not necessarily required to use these dead times as the optimum value. It is also possible to use one of the dead times td2_1, td2_6 and td2_7 at which the duty cycle is greater than minimum as the optimum value. That is, the optimum dead time can be selected according to the dead time at which the duty cycle is minimized. Therefore, the embodiment is not limited to the dead time at which the duty cycle is minimum. The optimum value is simply determined according to the duty cycle.

Specifically, the dead time is adjusted by adjustment of the delay values of the delay generation circuit. The dead time is varied within an allowable range covered by the adjustment of the delay values of the delay generation circuit, and the dead time minimizing the duty cycle is selected as the setting value.

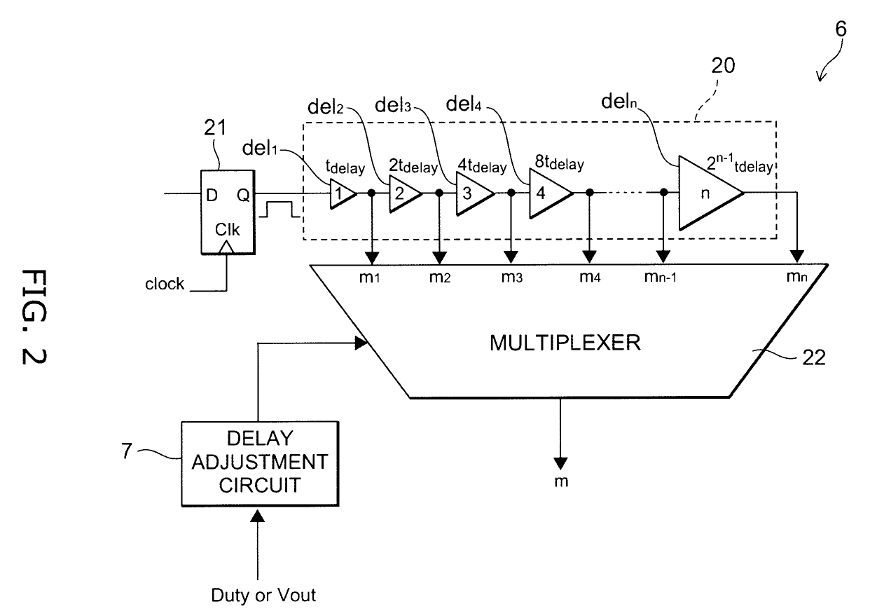

FIG. 2 shows a detailed configuration of the dead time setting circuit 6 including the delay generation circuit 20. Besides the delay generation circuit 20, the dead time setting circuit 6 further includes a delay adjustment circuit 7, and a multiplexer 22 serving as a selection circuit.

The delay generation circuit 20 includes a plurality of (n-stage) delay elements del₁-delₙ connected in series. Each of the delay elements del₁-delₙ is illustratively configured using a CMOS device.

Each of the delay elements del₁-delₙ has a different delay value (delay time). For example, the delay value, t_{delay}, of the first-stage delay element del₁ is selected to be relatively short. The delay value of the second-stage delay element del₂ is twice (2tdelay) the first-stage delay value, the delay value of the third-stage delay element del₃ is four times (4tdelay) the first-stage delay value, . . . , and the delay value of the nth-stage delay element delₙ is 2ⁿ⁻¹ times (2ⁿ⁻¹tdelay) the first-stage delay value. Thus, in the example shown in FIG. 2, a plurality of delay elements del₁-delₙ are series connected (cascaded) in ascending order of delay values from the first stage del₁ to the last stage delₙ.

However, the total of the delay values tdelayᵢ of all the delay elements del₁-delₙ (the total delay time) is made smaller than the fundamental clock cycle, Tclk. More specifically, it is required to satisfy the following formula (1), where the delay value of the first-stage delay element is tdelay₁, the delay value of the second-stage delay element is tdelay₂, . . . , and the delay value of the nth-stage delay element is tdelayₙ.

$${\sum }_{i = 1}^{n} {tdelay}_{i} \leq {T}_{clk} \qquad ( 1 )$$

In synchronization with the rising edge of the clock, the output signal of the flip-flop 21 is inputted to the first-stage delay element del₁. This signal inputted to the first-stage delay element del₁ is a pulse signal having a pulse width of one cycle of the clock. The pulse signal is transmitted through the delay elements del₁-delₙ sequentially from the first stage, and a delay is produced at the rising edge of the output signal m₁-mₙ of each of the delay elements del₁-delₙ.

The output signals m₁-mₙ of the delay elements del₁-delₙ are inputted to the multiplexer 22. On the basis of a control signal from the delay adjustment circuit 7, the multiplexer 22 selects one of the output signals m₁-mₙ of the delay elements del₁-delₙ for output. The output signal m of the multiplexer 22 determines the rising edge and falling edge which define the dead time of the switching pulse that the digital control circuit 5 outputs to the gate of the switching elements Q1 and Q2.

On the basis of the dead time optimization algorithm described above with reference to FIG. 4, the delay adjustment circuit 7 determines which of m₁-mₙ to select.

For example, at the beginning, the signal m₁, which has passed through only the first stage, is selected. Next, the signal m₂, which has passed through the first and second stage, is selected. If this results in increasing the duty cycle, the duty cycle has exceeded its minimum for the dead time defined by the signal m₂, and hence the dead time is defined by the signal m₁. If the duty cycle decreases, the duty cycle has yet to reach its minimum for the dead time defined by the signal m₂, and hence the next signal m₃ is used. If this results in increasing the duty cycle, the duty cycle has exceeded its minimum, the previous signal m₂ is used. As long as the decrease of the duty cycle continues, the duty cycle has yet to reach its minimum. Hence, the signals m₄, m₅, . . . , mₙ are sequentially selected, and the above step is repeated until the duty cycle is minimized.

As described above, the delay values of the delay generation circuit 20 are adjusted to set an optimal dead time so that the duty cycle of the switching pulse is minimized. This is performed for both the dead time of the interval in which the low-side switching element Q2 transitions from ON to OFF and the high-side switching element Q1 transitions from OFF to ON, and the dead time of the interval in which the high-side switching element Q1 transitions from ON to OFF and the low-side switching element Q2 transitions from OFF to ON. These dead times are optimized to realize a highly efficient DC-DC converter. The established optimal dead times and the delay values of the delay generation circuit 20 determining the dead times are held in a memory provided in the dead time setting circuit 6, and these setting values subsequently continue to be used.

Adjustment of the dead time is realized by digitally controlled pulse width modulation based on a clock. Here, the pulse edge needs to be adjusted with a smaller increment than the clock cycle. Hence, the delay generation circuit capable of generating a pulse edge subdividing a clock cycle is used.

Currently, it is difficult to exactly divide one clock cycle into n. Hence, for example, a configuration is proposed in which numerous units are connected in series, each unit including a delay element having a onefold delay value and a delay element having a twofold delay value connected in parallel, and the overall path is determined by suitably selecting the path of the onefold delay value and the path of the twofold delay value so that the total delay value (delay time) does not exceed the fundamental clock cycle. However, this configuration requires numerous delay elements, and hence increases the space for the delay generation circuit in the semiconductor chip, and the power consumption. It is desired to avoid wastefully increasing the circuit scale and power consumption of the delay generation circuit, which is needed only in setting the dead time and is not used during operation of the DC-DC converter after the setting.

The delay generation circuit 20 in this embodiment has a configuration in which a plurality of delay elements del₁-delₙ having mutually different delay values are connected in series. Hence, the total delay value not exceeding the clock cycle can be easily realized using a relatively small number of delay elements. Furthermore, the pulse edge can be adjusted so as to define the dead time with a higher resolution than the clock cycle. Thus, high resolution can be realized without the need for a high-rate clock, and the increase of cost and power consumption due to such need can be avoided.

Furthermore, the optimal value of the dead time is roughly estimated at design time, and the dead time is optimized as described above for each device in accordance with variations in the device. Hence, the scope of search for the optimal dead time is considerably narrowed. Thus, delay value adjustment with increments in multiple stages based on numerous delay elements is not needed, but even an adjustment range with a small number of stages based on a relatively small number of delay elements is sufficient.

As described above, according to this embodiment, while preventing the circuit scale and power consumption from increasing, the optimal value of the dead time can be established with high resolution, and the efficiency of the DC-DC converter can be improved.

It is noted that the invention is not limited to determining the setting value of the dead time on the basis of the correlation between the dead time and the duty cycle of the switching pulse. If the above output voltage Vout is high, the efficiency of the DC-DC converter (output power/input power) is high. Hence, the dead time maximizing the output voltage Vout can be selected as the optimal value to maximize the efficiency.

That is, the delay values of the delay generation circuit 20 are adjusted to determine the setting value of the dead time on the basis of the correlation between the dead time and the output voltage Vout. Specifically, the dead time is varied within an allowable range covered by the adjustment of the delay values of the delay generation circuit 20, and the dead time maximizing the output voltage Vout is selected as the setting value.

FIG. 6 shows graphs of efficiency and output voltage versus the dead time. As shown, suppose that the dead time at which the output voltage Vout is maximum is td2_3. The above embodiment has been described taking an example of using the dead td2_3 as the optimum value. However, it is not necessarily required to use td2_3 as the optimum value. It is also possible to use one of the dead times td2_1, td2_2, td2_4 and td2_5 at which the output voltage is lower than maximum as the optimum value. That is, the embodiment is not limited to the dead time at which the output voltage is maximum. The optimum value is simply determined according to the output voltage.

The configuration of the plurality of delay elements del₁-delₙ is not limited to the sequential connection from the first stage to the last stage in ascending order of delay values. The sequential connection in descending order of delay values is also possible. Furthermore, the delay values do not need to be increased in even multiples. Each delay element can take any delay value as long as the delay values of the delay elements are mutually different and satisfy the relation of the above formula (1).

The above embodiment has described the case where the invention is applied to a step-down DC-DC converter (buck converter). However, the invention is not limited thereto, but can be similarly practiced in other DC-DC converters to achieve similar effects. Furthermore, the configuration of the invention, such as the number of output bits of the A/D conversion circuit 30, the initial delay value, the increment, and the magnitude relationship of delays, can be variously modified and implemented without departing from the spirit of the invention.

1. A semiconductor device comprising:
a digital control circuit configured to supply two semiconductor switching elements connected in series in a switching power supply circuit with a pulse signal for turning on/off the semiconductor switching elements; and
a dead time setting circuit configured to set a dead time in which the two semiconductor switching elements are both turned off,
the dead time setting circuit including:
a delay generation circuit including a plurality of delay elements connected in series and having mutually different delay values; and
a delay adjustment circuit configured to adjust the delay values of the delay generation circuit so that a setting value of the dead time is determined on basis of correlation between the dead time and the duty cycle of the pulse signal.

2. The semiconductor device according to claim 1, wherein the dead time setting circuit varies the dead time within an allowable range covered by the adjustment of the delay values of the delay generation circuit and selects the dead time minimizing the duty cycle as the setting value.

3. The semiconductor device according to claim 1, wherein the dead time setting circuit determines the setting value of the dead time on basis of comparison between a present value and a running average of the duty cycle.

4. The semiconductor device according to claim 1, wherein the duty cycle is calculated on basis of an output voltage of the switching power supply circuit.

5. The semiconductor device according to claim 1, wherein the dead time setting circuit further includes a selection circuit configured to select one of output signals of the delay elements on basis of a control signal from the delay adjustment circuit.

6. The semiconductor device according to claim 1, wherein the plurality of delay elements are connected in series from the first stage to the last stage with mixed connection of high delay value elements and low delay value elements.

7. The semiconductor device according to claim 1, wherein
the pulse signal having a pulse width of one clock cycle is inputted to the first-stage delay element of the plurality of delay elements, and
the total of the delay values of all the delay elements is smaller than the clock cycle.

8. The semiconductor device according to claim 1, wherein the delay values of the delay elements are different in even multiples.

9. The semiconductor device according to claim 1, wherein the switching power supply circuit is a DC-DC converter.

10. The semiconductor device according to claim 1, wherein one of the two semiconductor switching elements is a high-side switching element connected between an input voltage terminal and an inductor in the switching power supply circuit, and the other is a low-side switching element connected between the inductor and ground.

11. The semiconductor device according to claim 10, wherein the digital control circuit supplies the pulse signal having a nearly inverted phase to the high-side switching element and the low-side switching element so that the high-side switching element and the low-side switching element are alternately turned on/off.

12. A semiconductor device comprising:
a digital control circuit configured to supply two semiconductor switching elements connected in series in a switching power supply circuit with a pulse signal for turning on/off the semiconductor switching elements; and
a dead time setting circuit configured to set a dead time in which the two semiconductor switching elements are both turned off,
the dead time setting circuit including:
a delay adjustment circuit configured to adjust the delay values of the delay generation circuit so that a setting value of the dead time is determined on basis of correlation between the dead time and an output voltage of the switching power supply circuit.

13. The semiconductor device according to claim 12, wherein the dead time setting circuit varies the dead time within an allowable range covered by the adjustment of the delay values of the delay generation circuit and selects the dead time maximizing the output voltage as the setting value.

14. The semiconductor device according to claim 12, wherein the dead time setting circuit further includes a selection circuit configured to select one of output signals of the delay elements on basis of a control signal from the delay adjustment circuit.

15. The semiconductor device according to claim 12, wherein the plurality of delay elements are connected in series from the first stage to the last stage with mixed connection of high delay value elements and low delay value elements.

16. The semiconductor device according to claim 12, wherein
the pulse signal having a pulse width of one clock cycle is inputted to the first-stage delay element of the plurality of delay elements, and
the total of the delay values of all the delay elements is smaller than the clock cycle.

17. The semiconductor device according to claim 12, wherein the delay values of the delay elements are different in even multiples.

18. The semiconductor device according to claim 12, wherein the switching power supply circuit is a DC-DC converter.

19. The semiconductor device according to claim 12, wherein one of the two semiconductor switching elements is a high-side switching element connected between an input voltage terminal and an inductor in the switching power supply circuit, and the other is a low-side switching element connected between the inductor and ground.

20. The semiconductor device according to claim 19, wherein the digital control circuit supplies the pulse signal having a nearly inverted phase to the high-side switching element and the low-side switching element so that the high-side switching element and the low-side switching element are alternately turned on/off.
